(19) United States
(12) Patent Application Publication
(10) Pub. No.: US 2009/0033464 A1
(43) Pub. Date: Feb. 5, 2009

(54) TRANSPONDER WITH ACCESS PROTECTION AND METHOD FOR ACCESS TO THE TRANSPONDER

(76) Inventor: Ulrich Friedrich, Ellhofen (DE)

Correspondence Address: Muncy, Geissler, Olds & Lowe, PLLC, P.O. BOX 1364, FAIRFAX, VA, 22038-1364, US

(21) Appl. No.: 12/057,340

(22) Filed: Mar. 27, 2008

Related U.S. Application Data
(60) Provisional application No. 60/907,327, filed on Mar. 28, 2007.

(30) Foreign Application Priority Data
Mar. 27, 2007 (DE) 10 2007 016 467.1

(51) Int. Cl. H04Q 5/22

(52) U.S. Cl. 340/10.1

(57) ABSTRACT

A transponder is provided having at least one memory area, whereby the memory area is assigned an access password, the access password is assigned at least one attribute bit, and the length and/or structure of the access password can be set by the attribute bit. The invention relates further to a method for access to at least one access password-protected memory subarea of the transponder and to an RFID system comprising a transponder.

This nonprovisional application claims priority to German Patent Application No. 102007016467.1, which was filed in Germany on Mar. 27, 2007, and to U.S. Provisional Application No. 60/907,327, which was filed on Mar. 28, 2007, and which are both herein incorporated by reference.

### BACKGROUND OF THE INVENTION

1. Field of the Invention

The invention relates to a transponder, whereby a memory area is assigned at least one access password. The invention relates further to a method for access to at least one transponder and an RFID system having at least one transponder.

2. Description of the Background Art

Transponders are used, for example, in contactless identification systems or so-called Radio Frequency Identification (RFID) systems. This type of system usually includes a base station or a reader or a reader unit and a plurality of transponders or remote sensors, which are located simultaneously within the response range of the base station. The transmission of power and data between the base station and the transponder occurs either through inductive coupling or through coupling with use of electromagnetic waves in the far field. The transponders or their transmitting and/or receiving devices typically do not have an active transmitter for data transmission to the base station. Transponders without active transmitters are called passive transponders when they do not have their own power supply and semipassive transponders when they have their own power supply. Passive transponders draw the power necessary for their supply from the electromagnetic field emitted by the base station or the emitted power.

So-called backscatter coupling is employed, as a rule, for data transmission from a transponder to a base station with UHF or microwaves in the far field of the base station. To that end, the base station emits electromagnetic carrier waves, which are modulated and reflected by the transmitting and receiving device of the transponder by means of a modulation method in accordance with the data to be transmitted to the base station. The typical modulation methods for this are amplitude modulation, phase modulation, and amplitude shift keying (ASK) subcarrier modulation, in which the frequency or the phase position of the subcarrier is modified.

An access control method for transponders is described in the draft standard ISO/IEC_CD 18000-6C of 7 Jan. 2005 (see particularly ISO/IEC_CD 18000-6C, Chapter 6.3.2, pages 27-60). The transponder in this case is first selected from a number of transponders in a selection or arbitration process. The described selection process is a stochastic process in the form of a slot-based ALOHA protocol. Selection methods of this kind are described in detail, for example, in the handbook by Klaus Finkenzeller, RFID-Handbuch [RFID Handbook], 3^{rd} ed., HANSER, 2002 (see particularly Chapter 7.2, Multiple Access Methods—Anticollision, pages 203 to 216).

For access, a base station typically transmits a so-called query command. The transponder responds to this query by transmitting a random number. The transponder is singled out by sending an acknowledgement (“Acknowledge”). The singled out transponder transmits protocol control bits (PC) and an identification in the form of a so-called electronic product code (EPC) to the reader unit. The protocol control bits contain information on a physical layer of the transmission path. The identification or the electronic product code EPC represents inter alia a product tagged with the transponder. The assignment of the EPC to the tagged product is standardized, so that the product can be inferred from the EPC information.

Typically, after the transmission of the PC and EPC by the transponder, read and/or write access to memory areas of the transponder by the base station is possible, unless the specific areas are blocked or locked for write access. Write protection is established, for example, by means of so-called lockbits. In this case, write protection for the entire memory area in conventional transponders is established by the lockbits.

RFID is employed in a multitude of different applications. In this case, this concerns both closed data management systems, i.e., systems in which the number and/or the type of data are set in the front end, and open data management systems, i.e., systems in which the data are constantly expanded and/or varied.

Particularly when a transponder or tag is to be used in an open data management system for a lifetime of a product tagged by the transponder, for example, for labeling a product, it is often desirable that read access to at least certain information, stored in the transponder, is not to be open to all participants. This information includes, for example, a manufacturing date, a current owner, etc. However, other data are to be made available by the transponder to a plurality of different reader units or base stations.

It is desirable during storage of personal data as well, for example, during use of a transponder in so-called chip cards, to regulate access to these data, for example, so that upon entry into a store it cannot be determined automatically by reading the memory contents whether the particular customer still has funds on the chip card.

It is conceivable, furthermore, that a potential attacker attempts to read data from a transponder in order to thus duplicate the transponder, for example, to place counterfeit products in circulation or to commit sabotage. Also for this reason it is desirable in many cases that, apart from passwords stored in the transponder, other data are also not freely accessible to all individuals.

Transponders are known in which a user memory area, also called a user memory bank, is partitioned into memory subareas and the memory subareas are each assigned a password for access protection. If different areas are protected by their own passwords, memory areas are provided for storing the passwords. To enable individual configuration of the transponder, a suitable memory area for passwords is therefore to be provided.

### SUMMARY OF THE INVENTION

It is therefore an object of the present invention to provide a transponder that makes possible a powerful and flexible access control to memory areas and efficient memory utilization. The object of the invention, furthermore, is to develop a method for access to memories subareas and an RFID system comprising a transponder of said type.

The object is attained in particular by a transponder with at least one memory area, whereby the memory area is assigned an access password, the access password is assigned at least one attribute bit, and the length and/or structure of the access password can be set by the attribute bit. As a result, individual adjustment of an access password is possible by only one additional bit, the so-called attribute bit.

In an embodiment of the invention, the memory area can be partitioned into memory subareas, whereby at least one memory subarea is assigned an access password. Different memory subareas can thereby be assigned a different protection.

In another embodiment of the invention, the transponder has means by which in the case of a set attribute bit, read and/or write access to the memory area and/or a memory subarea is protected by the access password and at least one confirmation password. As a result, it is possible to increase individually an effective password length and thereby protection for the memory area and/or for certain memory subareas by using several passwords by means of only one additional bit, the attribute bit. The protection of data stored in the transponder can thus be configured individually.

In an embodiment of the transponder, in the case of a set attribute bit, the access password of the memory area and/or the memory subarea is protected by a general password. In regard to the invention, designated as a general password is a password that applies equally to all memory subareas, for example, an access password for read and/or a write access to the entire released memory area of the transponder. In other words, for example, in an embodiment of the read and/or write access to a memory subarea, both a general and individual authorization is required.

In another embodiment of the transponder, passwords of several memory subareas are stored in sequences with a settable bit length, preferably a bit length of 16 bits, in a password area of the transponder's memory area. It is possible by means of the sequences to set any password lengths for passwords of individual memory subareas, whereby, however, basically a set sequence length is to be maintained for simplified addressing.

In another embodiment of the transponder, in the case of a set attribute bit, an access password of a memory subarea is protected by a preceding or subsequent access password stored in the password area. If an attribute bit is also set for the preceding or subsequent access password, an additional confirmation password for access authorization is necessary. It is possible thereby to assign a tiered protection to individual memory subareas. For example, all individuals in a group may have read and/or write access to the transponder via a general access password. However, this does not enable access to certain memory subareas of the transponder with security-relevant data or data requiring data protection. Access to these data requires an additional access password, which is provided only to a subgroup. Within these data, data are to be determined in turn which require increased protection. Access to these data in the example therefore requires a third access password, which, for example, is made known only to a supervisor, head, or director of the group.

In another embodiment of the transponder, at least one password is protected by an asymmetric encryption method. Particularly in the case of open systems, the cost necessary for key management can be reduced.

In another embodiment of the invention, the transponder has a flag for signaling a type of encryption or the like. It is possible in this way to use different transponders in a common system. Thus, for example, in a transponder, read access from outside to all passwords or individual passwords stored in the transponder can be basically blocked, whereby in an embodiment checking of the passwords occurs by means of a hash function.

The object is attained further by means of a method for access to at least one access password-protected memory area and/or memory subarea of a transponder, whereby an attribute bit assigned to the access password is evaluated. The attribute bit determines the structure and/or length of the password. By evaluating the attribute bit during an access procedure, the access method can be adapted accordingly to the structure and/or length of the access password.

In a development of the method, a command is transmitted from a base station to the transponder, which comprises at least one pointer to a memory area of the transponder in which the access password is stored. By transmitting the pointer for access, it is possible to store the password in different, variable memory areas. In this case, in an embodiment, a certain memory bank of the transponder can also be selected by the command. This makes it possible to optimally use the memory area of the transponder.

In a development of the method, an access command is transmitted as a command, whereby at least the access password and a confirmation password are transmitted with the access command. If the confirmation password in turn again requires a confirmation password, this is also to be transmitted by the access command.

In still another development of the method, the passwords are transmitted encrypted. Basically, to prevent unauthorized eavesdropping of passwords in the forward channel, i.e., from the base station to the transponder, passwords are not to be transmitted unencrypted. If more than two passwords are transmitted simultaneously, it is conceivable to encrypt the passwords through themselves, for example, to link two passwords by means of an XOR operation. For decoding, it is then assumed in the case of the transponder that the base station knows a least one password and this password is used for extracting and verifying the second password. Alternatively or in addition, encryption can occur by means of a random number provided by the transponder to the base station or by means of a key of an asymmetric encryption method.

In still another development of the method, a random number is requested by the command, whereby the random number is encrypted with the access password of a memory subarea. A typical routine for access to a memory area of a transponder comprises a request for a random number by a base station by which passwords transmitted subsequently from the base station to the transponder for access are encrypted. Customarily, the random number is transmitted unencrypted from the transponder to the base station, i.e., in the backward channel. Because backward channel eavesdropping is incomparably more difficult than forward channel eavesdropping, this transmission is usually not critical. In some applications, however, for reasons of security, backward channel eavesdropping is to be prevented as well. By encryption of the random number with the access password, extraction of the random number by the base station is possible only if the access password is known. In a subsequent step, for example, the confirmation password can be encrypted by the base station with the extracted random number and transmitted in this way to the transponder. The access to the memory subarea is thereby indirectly protected by the access password and the confirmation password. Of course, encryption of the random number by means of the confirmation password is also conceivable.

In still another development of the method, at least one attribute flag is transmitted with the command to the transponder, whereby the attribute flag indicates an encryption of the transmitted passwords, the type of encryption, and/or the like. It is possible in turn by means of the attribute flag to use different transponders in a common system. This can be important, for example, when transponders of different generations are used together in an RFID system.

Further, the object is attained by an RFID system comprising at least one base station and at least one transponder having at least one access password-protected memory area, whereby the access password is assigned an attribute bit and the length and/or the structure of the access password can be set by the attribute bit.

In an embodiment, power and/or data can be transmitted from the base station to the transponder by an electromagnetic far field and/or by inductive coupling. Depending on the distance between base station and transponder, transmission in the near field or in the far field is to be selected.

Additional advantages of the invention emerge from the following description of exemplary embodiments of the invention, which are shown schematically in the drawings. All features and/or advantages emerging from the claims, description, or drawings, including process steps, structural details, and spatial arrangements, can be essential to the invention both alone and in the most diverse combinations. Features described or presented as part of an exemplary embodiment can also be used in another exemplary embodiment, to achieve another embodiment of the invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a schematic depiction of a memory area assignment in a transponder;

FIG. 2 is a flowchart of an access method to a protected memory subarea of a transponder, and

FIG. 3 is a flowchart of a second access method to a protected memory subarea of a transponder.

### DETAILED DESCRIPTION

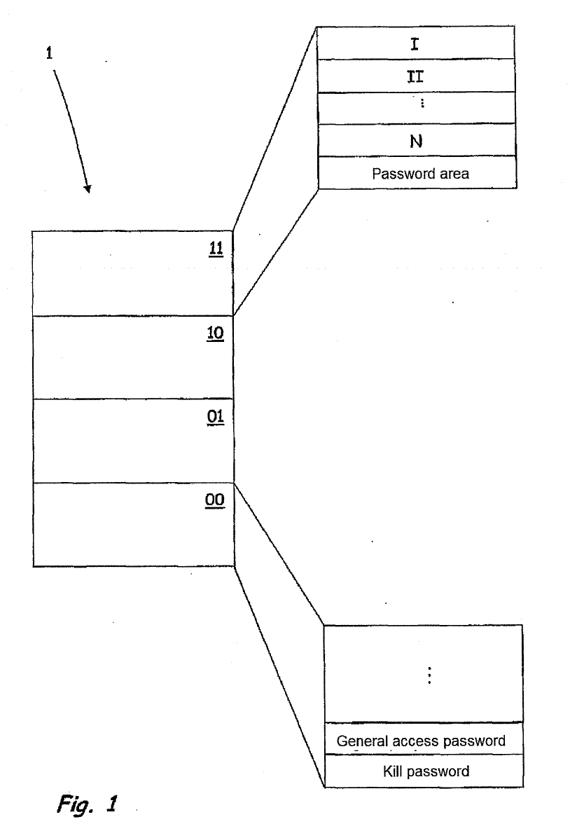

FIG. 1 shows schematically a memory area 1 of a transponder. Memory area 1 in this case is divided is memory banks 00, 01, 10, and 11 provided according to the draft standard ISO/IEC_CD 18000-6C. Memory bank 00 is typically called a reserved memory area (reserved memory). A so-called kill password, for permanent muting or killing a transponder, and general access passwords, such as the access password provided according to the aforementioned draft standard, are stored in memory bank 00.

Memory bank 01 is also called an EPC memory area. Protocol control bits and an electronic product code (EPC) are typically stored in memory bank 01.

Memory bank 10 is typically a so-called transponder identification memory area (TID memory). Information by which, for example, a transponder can be clearly identified is stored in memory bank 10.

Memory bank 11 forms the so-called user memory area (user memory), in which any information to be determined by a user can be stored. Memory bank 11 can be partitioned individually by a user into memory subareas I, II, . . . , N and a password area. In other embodiments, partitioning is done by a manufacturer. The individual memory subareas. I, . . . , N can thereby each be assigned an access password. In the depicted exemplary embodiment, the access passwords are stored in a password area provided in memory bank 11. In other embodiments of the invention, the passwords can also be stored in memory bank 00 and/or in a shadow area. The access passwords for memory subareas I, . . . , N according to the invention are assigned attribute bits, whereby the attribute bits can be set or not set. In the case of the set attribute bit, read and/or write access to an associated memory subarea requires transmission of a confirmation password in addition to transmission of the access password. The general access password, stored in memory bank 00, and/or parts thereof can be used as the confirmation password, for example. Typically, the general access password is a two-part password, whereby each password part comprises 16 bits. In other embodiments, a general, higher-order password, a so-called default password, is stored in user memory bank 11. A method for access control to memory bank 11 must therefore not resort to other memory banks, such as, for example, reserved memory bank 00. Individual passwords, which are stored in the password area, can be stored sequentially. Each sequence preferably has a length of 16 bits. Passwords, assigned to the individual memory subareas I, . . . , N, can thereby have any bit length, which is a multiple of 16 bits, for example, 32, 48, 64, or 96 bits.

The passwords can be stored encrypted in the password area of memory bank 11 and/or in memory bank 00. An encryption can be signaled, for example, by appropriate protocol control bits or by additional protocol control bits (XPC).

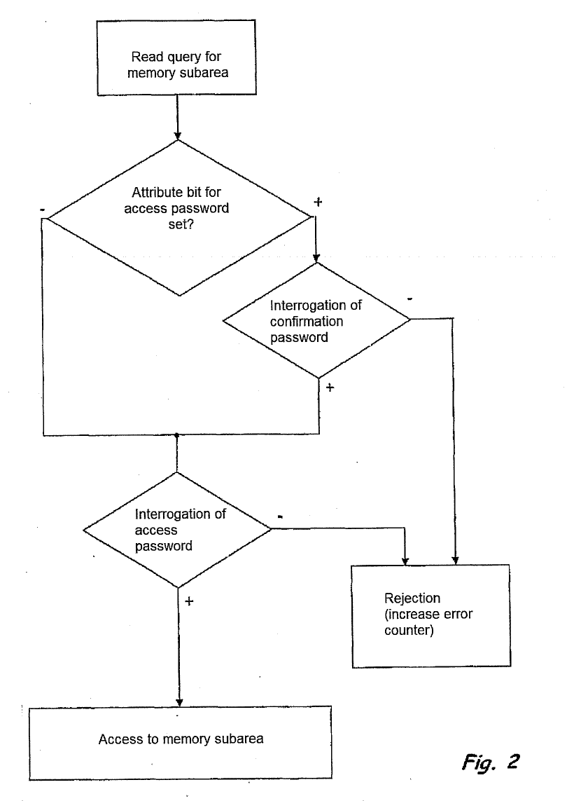

FIG. 2 shows schematically a flowchart for access control to a memory subarea, which is protected against reading by an access password. For read access to the memory subarea, a base station first sends a read query to the transponder. If the attribute bit of the access password is not set, an interrogation of the access password follows, whereby in the case of correct transmission of the access password, read access to the associated memory subarea is released. If, on the contrary, the attribute bit for the access password is set, whereby a set state can be signaled by a “0” or a “1,” interrogation of a confirmation password occurs first. The interrogation of the access password occurs in another step only after correct transmission of the confirmation password.

Transmission of incorrect passwords leads to a rejection. In an embodiment, an error counter can be provided which is increased with each failed attempt. In this case it can be provided in an embodiment that when a set number of failed attempts is reached access to the memory subarea and/or the entire transponder in general is blocked. Of course, the method according to FIG. 2 can be used analogously for write access to a write-protected memory subarea.

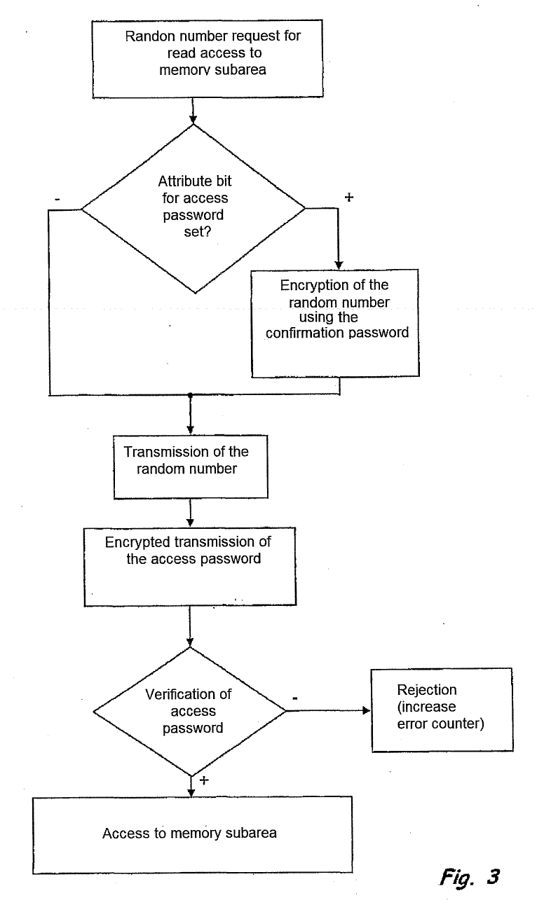

FIG. 3 shows a flowchart for an alternative access control for read access to a memory subarea. In this case, in a first step first a random number is requested by the base station. A command is used for this which essentially corresponds to a customary random number request command. The command can have in addition a pointer to a memory area in which the password for the desired memory subarea is stored. If no attribute bit is set for the access password, generation and transmission of a random number to the base station occur without encryption. The base station encrypts an access password for the memory subarea with the received random number and sends this again to the transponder. After successful verification of the access password, access to the memory subarea is released. However, if the attribute bit of the access password is set, a random number generated by the transponder is encrypted by the confirmation password and transmitted encrypted to the base station. An encrypted transmission is indicated here to the base station by a flag bit or the like in a transmission signal. The base station knowing the confirmation password can extract the random number from the received signal and in a next step transmit an access password, which was encrypted by the random number, to the transponder for access to the corresponding memory subarea. The method according to FIG. 3 can also be used similarly for write access. The password can be stored in any location by transmission of the pointer. This enables individual configuration of the transponder.

Because of the possibility of protecting access passwords to certain memory subareas by a confirmation password or several confirmation passwords, a security level can be established for individual memory subareas as desired, without impairing access to other memory subareas for this. It is possible, moreover, to increase the security without increasing the number of passwords provided overall and thereby a memory space requirement.

In one application, a transponder of the invention can be used, for example, with a sensor system for monitoring security-relevant systems in a motor vehicle. In this case, the data gathered by the sensor system are stored in the transponder and are then available for quality monitoring. It is conceivable in this case that not all data are to be read to the same extent by all actors. It is conceivable, for example, that data with a low security relevance are basically available to each actor, for example, during manufacturing, in a workshop, and/or in a contract-based, security-monitoring workshop. Other data, however, are to be available only to a specific user group, for example, the manufacturer. It is possible according to the invention to configure individually the access to certain memory subareas and thus to adapt the transponder to a specific application.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A transponder comprising at least one memory area, the memory area being assigned an access password, which is assigned at least one attribute bit, wherein a length and/or structure of the access password is set by the attribute bit.

2. The transponder according to claim 1, wherein the memory area is partitioned into memory subareas, wherein at least one memory subarea is assigned an access password.

3. The transponder according to claim 1, wherein the transponder has a component by which in the case of a set attribute bit, read and/or write access to the memory area and/or a memory subarea is protected by the access password and at least one confirmation password.

4. The transponder according to claim 1, wherein in the case of the set attribute bit, the access password of the memory area and/or the memory subarea is protected by a general password and/or parts thereof.

5. The transponder according to any claim 2, wherein passwords of several memory subareas are stored in sequences with a settable bit length, preferably a bit length of 16 bits, in a password area of the transponder's memory area.

6. The transponder according to claim 5, wherein in case of a set attribute bit, the access password of the memory subarea is protected by a preceding or subsequent access password of another memory subarea, the password being stored in the password area.

7. The transponder according to claim 1, wherein at least one of the access passwords is protected by an asymmetric encryption method.

8. The transponder according to claim 7, wherein the transponder has a flag for signaling an employed encryption type or the like.

9. A method for access to at least one access password-protected memory area and/or memory subarea of a transponder, the method comprising:
assigning at least one memory area of the transponder an access password, which is assigned at least one attribute bit, wherein a length and/or structure of the access password is set by the attribute bit;
evaluating the attribute bit of the access password is evaluated; and
granting access to the at least one access password-protected memory area or memory subarea based on the evaluation of the attribute bit.

10. The method according to claim 9, wherein a command is transmitted from a base station to the transponder, which comprises at least one pointer to a memory area of the transponder in which the access password is stored.

11. The method according to claim 10, wherein an access command is transmitted as a command, whereby at least the access password and a confirmation password are transmitted with the access command.

12. The method according to claim 11, wherein the access password or the confirmation password is transmitted encrypted at least from the base station to the transponder.

13. The method according to claim 12, wherein a random number is requested by the command, whereby the random number is encrypted with the access password of the memory area and/or a memory subarea.

14. The method according to claim 9, wherein at least one attribute flag is transmitted with the command to the transponder, wherein the attribute flag indicates an encryption of the transmitted passwords or the type of encryption.

15. An RFID system comprising:
at least one transponder comprising at least one memory area, the memory area being assigned an access password, which is assigned at least one attribute bit, wherein a length and/or structure of the access password is set by the attribute bit; and
a base station for communicating with the at least one transponder.

16. The RFID system according to claim 15, wherein power and/or data are transmitted from the base station to the transponder by an electromagnetic far field and/or by inductive coupling.
